(19) United States
(12) Patent Application Publication
(10) Pub. No.: US 2015/0016509 A1
(43) Pub. Date: Jan. 15, 2015

(54) APPARATUSES AND METHODS FOR ADJUSTING A QUANTIZATION PARAMETER TO IMPROVE SUBJECTIVE QUALITY

(71) Applicant: Magnum Semiconductor, Inc., Milpitas, CA (US)

(72) Inventor: Pavel Novotny, Waterloo, CA (US)

(21) Appl. No.: 13/937,733

(22) Filed: Jul. 9, 2013

(51) Int. Cl. H04N 19/126; H04N 19/139

(52) U.S. Cl. CPC H04N 19/00096; H04N 19/00151
USPC 375/240.03

(57) ABSTRACT

Apparatuses and methods for adjusting a quantization parameter to improve subjective quality are described herein. An example apparatus may include an encoder that may be configured to receive a macroblock and calculate a ratio between a level of activity of the macroblock and a variance of the macroblock. The encoder may further be configured to selectively adjust a quantization parameter associated with the macroblock based, at least in part, on the ratio.

### TECHNICAL FIELD

Embodiments of this invention relate generally to video encoding, and examples of systems and methods for adjustment of quantization parameters are described.

### BACKGROUND

Video or other media signals may be used by a variety of devices, including televisions, broadcast systems, mobile devices, and both laptop and desktop computers. Typically, devices may display video in response to receipt of video or other media signals, often after decoding the signal from an encoded form. Video signals provided between devices are often encoded using one or more of a variety of encoding and/or compression techniques, and video signals are typically encoded in a manner to be decoded in accordance with a particular standard, such as MPEG-2, MPEG-4, and H.264/MPEG-4 Part 10. By encoding video or other media signals, then decoding the received signals, the amount of data provided between devices may be significantly reduced.

Video encoding typically proceeds by sequentially encoding macroblocks, or other coding units, of video data. Prediction coding may be used to generate predictive blocks and residual blocks, where the residual blocks represent a difference between a predictive block and the block being coded. Prediction coding may include spatial and/or temporal predictions to remove redundant data in video signals, thereby further improving data compression. Intracoding for example, is directed to spatial prediction and reducing the amount of spatial redundancy between blocks in a frame or slice. Intercoding, on the other hand, is directed toward temporal prediction and reducing the amount of temporal redundancy between blocks in successive frames or slices. Intercoding may make use of motion prediction to track movement between corresponding blocks of successive frames or slices.

Typically, in encoder implementations, including intracoding and intercoding based implementations, residual blocks (e.g., difference between actual and predicted blocks) may be transformed and/or quantized, and entropy encoded to generate a coded bitstream. The coded bitstream may be transmitted between the encoding device and the decoding device. Quantization may determine the amount of loss that may occur during the encoding of a video signal. That is, the amount of data that is removed from a video signal during an encoding process may depend on a quantization parameter.

Many current approaches to quantization adjust a quantization parameter to improve quality for a particular bit rate or to improve bit rate for a particular quality. However, these approaches can often undesirably adjust a quantization parameter and/or misidentify content resulting in a decrease of subjective quality for a particular bit rate.

### BRIEF DESCRIPTION OF THE DRAWINGS

FIG. 1 is a block diagram of an encoder according to an embodiment of the present invention.

FIG. 2 is a block diagram of an encoder according to an embodiment of the present invention.

FIG. 3 is a flowchart of a method for providing an activity-variance ratio of a macroblock according to an embodiment of the present invention.

FIG. 4 is a flowchart of a method for correcting an activity-variance ratio of a macroblock having relatively low activity according to an embodiment of the present invention.

FIG. 5 is a flowchart of a method for selectively adjusting a quantization parameter using an activity-variance ratio according to an embodiment of the present invention.

FIG. 6 is a flowchart of a method for is a flowchart of a method for selectively adjusting a quantization parameter using an activity-variance ratio according to an embodiment of the present invention.

FIG. 7 is a schematic illustration of a media delivery system according to an embodiment of the invention.

FIG. 8 is a schematic illustration of a video distribution system that may make use of encoders described herein.

### DETAILED DESCRIPTION

Examples of apparatuses and methods for adjusting a quantization parameter to improve subjective quality are described herein. In accordance with one or more described embodiments, an activity-variance ratio may be calculated from activity and/or variance of a macroblock and used to classify content of the macroblock. Based on the activity-variance ratio and the classification, a quantization parameter of the macroblock may be adjusted such that subjective quality is improved. Certain details are set forth below to provide a sufficient understanding of embodiments of the invention. However, it will be clear to one having skill in the art that embodiments of the invention may be practiced without these particular details, or with additional or different details. Moreover, the particular embodiments of the present invention described herein are provided by way of example and should not be used to limit the scope of the invention to these particular embodiments. In other instances, well-known video components, encoder or decoder components, circuits, control signals, timing protocols, and software operations have not been shown in detail in order to avoid unnecessarily obscuring the invention.

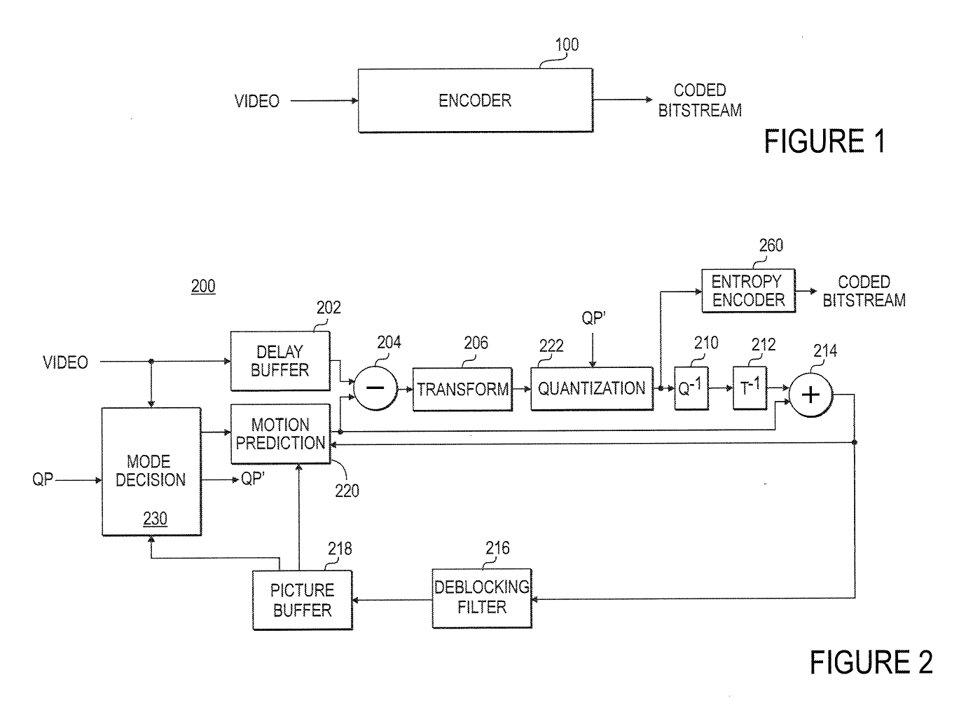

FIG. 1 is a block diagram of an apparatus in the form of an encoder 100 according to an embodiment of the invention. The encoder 100 may include one or more logic circuits, control logic, logic gates, processors, memory, and/or any combination or sub-combination of the same, and may be configured to encode and/or compress a video signal using one or more encoding techniques, examples of which will be described further below. The encoder 100 may be configured to encode, for example, a variable bit rate signal and/or a constant bit rate signal, and generally may operate at a fixed rate to output a bitstream that may be generated in a rate-independent manner. The encoder 100 may be implemented in any of a variety of devices employing video encoding, including, but not limited to, televisions, broadcast systems, mobile devices, and both laptop and desktop computers.

In at least one embodiment, the encoder 100 may include an entropy encoder, such as a variable-length coding encoder (e.g., Huffman encoder or CAVLC encoder), and/or may be configured to encode data, for instance, at a macroblock level. Each macroblock may be encoded in intra-coded mode, inter-coded mode, bidirectionally, or in any combination or subcombination of the same.

By way of example, the encoder 100 may receive and encode a video signal that includes a plurality of sequentially ordered coding units (e.g., block, macroblock, slice, frame, field, group of pictures, sequence). The video signal may be encoded in accordance with one or more encoding standards, such as MPEG-2, MPEG-4, H.263, H.264, H.265, and/or HEVC, to provide a coded bitstream. The coded bitstream may in turn be provided to a data bus and/or to a device, such as a decoder or transcoder (not shown in FIG. 1). A video signal may include a transient signal, stored data, or both.

To encode each macroblock of a video signal, the encoder may utilize a standard mode decision process and identify a standard quantization parameter. The quantization parameter may, for instance, by provided from an external device and/or a user or may be generated by the encoder 100. The standard quantization parameter may be identified in accordance with any suitable encoding methodologies, including those directed to rate control and/or adaptive quantization. As will be explained, the encoder 100 may adjust the standard quantization parameter of a macroblock based, at least in part, on activity and/or variance of the macroblock. For example, the encoder 100 may be configured to provide an activity-variance (AV) ratio, and based, at least in part, on the AV ratio, may classify content of the macroblock and/or adjust the quantization parameter of the macroblock. Adjusting the quantization parameter in this manner may improve subjective quality of a coded bitstream.

FIG. 2 is a block diagram of an encoder 200 according to an embodiment of the present invention. The encoder 200 may be used to implement, at least in part, the encoder 100 of FIG. 1, and may further be compliant with one or more known coding standards, such as MPEG-2, H.264, and H.265 coding standards.

The encoder 200 may include a mode decision block 230, a motion prediction block 220, a delay buffer 202, a subtractor 204, a transform 206, a quantization block 222, an entropy encoder 260, an inverse quantization block 210, an inverse transform block 212, an adder 214, a deblocking filter 216, and a decoded picture buffer 218. The mode decision block 230 may receive an incoming video signal (e.g. a transient signal or stored data from a memory) and may determine an appropriate coding mode for the video signal based on properties of the video signal and a decoded picture buffer signal. The mode decision block may determine an appropriate coding mode on a per frame and/or macroblock basis. The mode decision may include macroblock type, intra modes, inter modes, syntax elements (e.g., motion vectors), and/or one or more quantization parameters. The mode decision block may further provide an adjusted quantization parameter QP′ for use by the quantization block 222 that may be calculated as an adjustment to an incoming quantization parameter QP.

The output of the mode decision block 230 may be utilized by the motion prediction block 220 to generate a predictor in accordance with one or more coding standards and/or other prediction methodologies. The predictor may be subtracted from a delayed version of the video signal at the subtractor 204. Using the delayed version of the video signal may provide time for the mode decision block 230 to act. The output of the subtractor 204 may be a residual, e.g. the difference between a block and a prediction for a block.

The transform 206 may perform a transform, such as a discrete cosine transform (DCT), on the residual to transform the residual to the frequency domain. As a result, an output of the transform 206 may be a block of coefficients that may, for instance, correspond to spectral components of data in the video signal. For example, the coefficient block may include a DC coefficient corresponding to a zero frequency component of the video signal. The DC coefficient may, for instance, represent an average value of the coefficient block. The coefficient block may further include one or more AC coefficients corresponding to higher (non-zero) frequency portions of the video signal.

The quantization block 222 may receive the block of coefficients and quantize the coefficients (e.g., DC coefficient and AC coefficients) to produce a quantized coefficient block. The quantization provided by the quantization block 222 may be lossy and/or may also utilize one or more quantization parameters, such as the adjusted quantization parameter QP′, to employ a particular degree of quantization for one or more coefficients of the coefficient block. A quantization parameter may correspond with an amount of spatial detail preserved during a respective quantization process. QP′ may be received from the mode decision block 230, but it will be appreciated that in some instances, QP′ may be specified by a user, or may be provided by another element of the encoder 200. The adjusted quantization parameter QP′ may be adjusted for each macroblock, and/or may be based on information encoded by the encoder 200. By way of example, macroblocks associated with higher activity in one or more components may generally be associated with a larger quantization parameter.

In turn, the entropy encoder 260 may encode the quantized coefficient block to provide a coded bitstream. The entropy encoder 260 may be any entropy encoder known by those having ordinary skill in the art or hereafter developed, such as a variable length coding (VLC) encoder or a context-adaptive binary arithmetic coding (CABAC) encoder. The quantized coefficient block may also be inverse-quantized by the inverse quantization block 210. The inverse-quantized coefficients may be inverse transformed by the inverse transform block 212 to produce a reconstructed residual, which may be added to the predictor at the adder 214 to produce reconstructed video. The reconstructed video may be deblocked by the deblocking filter 216, and provided to the decoded picture buffer 218 for use in future frames, and further may be provided from the decoded picture buffer 218 to the mode decision block 230 for further in-macroblock intra prediction or other mode decision methodologies.

As described, the mode decision block 230 may provide an adjusted quantization parameter QP′ to the quantization block 222. In at least one embodiment, QP′ may be based, at least in part, on the incoming video signal, and in particular, activity and/or variance of a video signal. For example, the mode decision block 230 may calculate an AV ratio, and based on the AV ratio, content of the macroblock may be classified into one of a plurality of types of regions. In turn, the mode decision block 230 may use the AV ratio and/or the classification to adjust the quantization parameter QP to provide the adjusted quantization parameter QP′. The mode decision block 230 may make particular adjustments to each of the types of regions.

Accordingly, in operation, the mode decision block 230 may receive a macroblock and measure activity and variance of the macroblock. Activity of a macroblock generally refers to a measure of how much the intensity of pixels of the macroblock vary between one another. Variance of a macroblock generally refers to a measure of how much the intensity of pixels of a macroblock vary from the DC coefficient of the macroblock. The mode decision block 230 may provide an AV ratio that is based on the respective magnitudes of activity and variance, and the resulting magnitude of the ratio may be used to classify the content of the macroblock. By way of example, macroblock content may be classified as an edge, a texture, and/or noise. The classification and/or AV ratio may subsequently be used to adjust the quantization parameter of the macroblock. In some embodiments, a quantization parameter may be decreased for macroblocks in frames having relatively low noise and/or for macroblocks comprising an edge.

The encoder 200 may operate in accordance with one or more video coding standards, such as H.264. In examples employing coding standards, such as H.264, which employ motion prediction and/or compensation, the encoder 200 may further include a feedback loop having an inverse quantization block 210, an inverse transform 212, and a reconstruction adder 214, a deblocking filter 216, and a picture buffer 218. These elements may mirror elements included in a decoder (not shown) that reverse, at least in part, the encoding process performed by the encoder 200. Additionally, the feedback loop of the encoder may include a prediction block 220 and a decoded picture buffer 218.

In an example operation of the encoder 200, a video signal (e.g. a base band video signal) may be provided to the encoder 200. The video signal may be provided to the delay buffer 202 and the mode decision block 230. The mode decision block 230 may receive a quantization parameter, for instance, from an external device, and may determine a quantization parameter QP′ based on the quantization parameter QP. The subtractor 204 may receive the video signal from the delay buffer 202 and may subtract a motion prediction signal from the video signal to generate a residual signal. The residual signal may be provided to the transform 206 and processed using a forward transform, such as a DCT. As described, the transform 206 may generate a coefficient block that may be provided to the quantization block 222, and the quantization block 222 may quantize and/or optimize the coefficient block. Quantization of the coefficient block may be based on the quantization parameter QP′, and quantized coefficients may be provided to the entropy encoder 260 and thereby encoded into a coded bitstream.

The quantized coefficient block may further be provided to the feedback loop of the encoder 200. That is, the quantized coefficient block may be inverse quantized and inverse transformed by the inverse quantization block 210 and the inverse transform 212, respectively, to produce a reconstructed residual. The reconstructed residual may be added to the predictor at the adder 214 to produce reconstructed video, which may be deblocked by the deblocking filter 216, written to the decoded picture buffer 218 for use in future frames, and fed back to the mode decision block 230 and the motion prediction block 220. Based, at least in part, on the reconstructed video signals, the motion prediction block 220 may provide a motion prediction signal to the adder 204.

Accordingly, the encoder 200 of FIG. 2 may provide a coded bitstream based on a video signal, where the coded bitstream is generated in part using adjusted quantization parameters QP′ provided in accordance with embodiments of the present invention. The encoder 200 may be operated in semiconductor technology, and may be implemented in hardware, software, or combinations thereof. In some examples, the encoder 200 may be implemented in hardware with the exception of the mode decision block 230 that may be implemented in software. In other examples, other blocks may also be implemented in software, however software implementations in some cases may not achieve real-time operation.

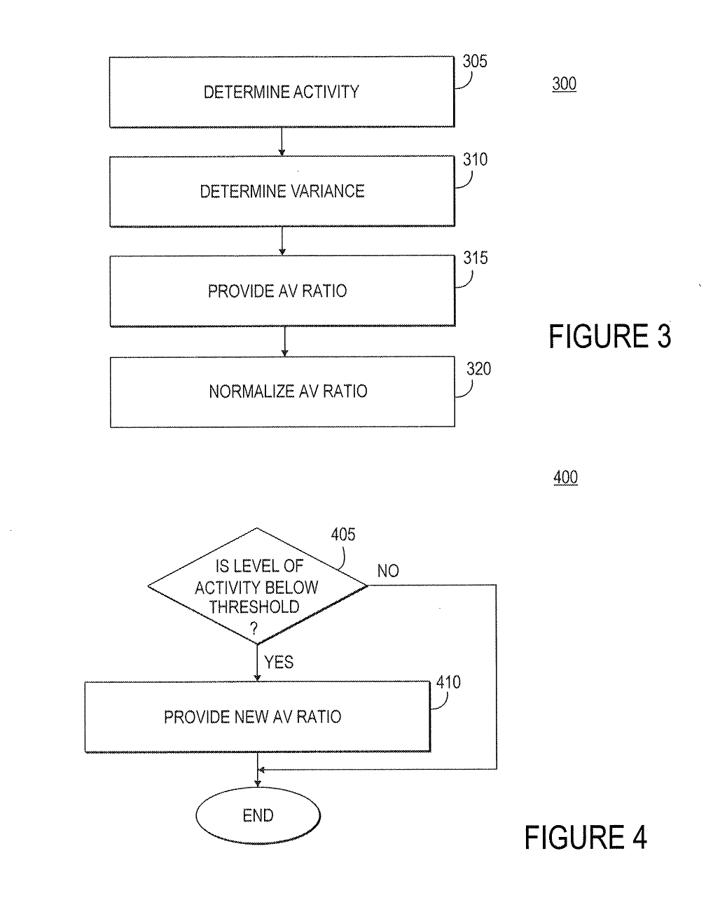

FIG. 3 is a flowchart of a method 300 for calculating an activity-variance ratio of a macroblock according to an embodiment of the present invention. The method 300 may be implemented using the mode decision block 230 of FIG. 2. At step 305, mode decision block 230 may determine the level of activity of a macroblock. The level of activity may, for instance, be determined by determining one or more pixel value differences in vertical and/or horizontal directions. For example, the mode decision block 230 may determine the level of activity in accordance with the following equation:

$$ACT = {\sum }_{y = 0}^{15} {\sum }_{x = 0}^{14} \vert {pixel}_{x , y} - {pixel}_{x + 1 , y} \vert + {\sum }_{y = 0}^{14} {\sum }_{x = 0}^{15} \vert {pixel}_{x , y} - {pixel}_{x , y + 1} \vert$$

where ACT represents the level of activity, x represents a horizontal pixel coordinate, and y represents a vertical pixel coordinate, and pixel_{x,y} refers to an intensity of a pixel at the location x,y. Accordingly, the activity of a macroblock may represent a measure of how much the intensity of pixels varies from pixel to pixel in the macroblock. Absolute intensity differences between adjacent pixels in both the x and y directions may be summed to arrive at the activity of a macroblock. Absolute intensity differences between adjacent pixels in an x direction may be summed for one row, and the sums themselves summed over all rows. The absolute intensity differences between adjacent pixels in the y direction may be summed for one column, and the sums themselves summed over all columns. Either of those sums may be utilized as an activity measure, or the sum of both may be used (e.g. as generally shown in the above equation).

At step 310, the mode decision block 230 may calculate the level of variance of the macroblock. The level of variance may be calculated by determining a difference between one or more pixel values and a DC coefficient of the macroblock. For example, the mode decision block 230 may first determine the DC coefficient in accordance with the following equation:

$$DC = \frac{{\sum }_{y = 0}^{15} {\sum }_{x = 0}^{15} {pixel}_{x , y}}{256}$$

where DC represents the DC coefficient, x represents a horizontal pixel coordinate, and y represents a vertical pixel coordinate, and pixel_{x,y} represents an intensity of the pixel at the location x,y. Accordingly, the DC coefficient may be an average of the pixel intensity in the macroblock. The above equation is for an example having 256 pixels per macroblock, but macroblocks having other sizes may be used in other examples, or an average may be taken over a portion of a macroblock. The DC coefficient may in some examples not be calculated by the mode decision block but instead provided to the mode decision block by another portion of the encoder or system including the encoder. The DC coefficient may be used to determine a variance of the macroblock in accordance with the following equation:

$$VAR = {\sum }_{y = 0}^{15} {\sum }_{x = 0}^{15} \vert {pixel}_{x , y} - DC \vert$$

where VAR represents the level of variance, x represents a horizontal pixel coordinate, and y represents a vertical pixel coordinate, and pixel_{x,y} represents an intensity of a pixel at the location x,y. Accordingly, the variance of the macroblock represents a sum of the absolute differences between each pixel and the DC coefficient (e.g. average intensity of the macroblock). The example equation above is provided for a macroblock having 16 rows and 16 columns, although other size macroblocks may be used in other examples, or a variance may be calculated over only a portion of a macroblock. In this manner, a variance may be larger for macroblocks having a wide variation in intensity from an average, while the variance may be smaller for macroblocks having a small variation in intensity from the average macroblock intensity.

At step 315, the mode decision block 230 may determine the AV ratio of the macroblock based, at least in part, on the respective levels of activity and variance determined at steps 305, 310, respectively. For example, the AV ratio may be determined in accordance with the following equation:

ACTVAR=ACT/VAR

where ACTVAR represents the AV ratio, ACT represents the level of activity, and VAR represents the level of variance, generally described above. Alternatively, the AV ratio may be determined in accordance with the following equation:

ACTVAR=ACT/(VAR+1)

where ACTVAR represents the AV ratio, ACT represents the level of activity, and VAR represents the level of variance. In this manner, “divide-by-zero” operations may be avoided for any macroblock having no variance. Other constants other than 1 may be added to VAR in other examples of calculating ACTVAR. As described, the AV ratio may be used to classify the content of a macroblock.

In this manner, examples described herein may calculate a metric representing a ratio between activity and variance of one or more macroblocks of a video signal. The ratio between activity and variance may generally also be described as a ratio between overall pixel-to-pixel variation in a macroblock and overall deviation from an average intensity.

At step 320, the AV ratio may be normalized. In at least one example, normalizing the AV ratio may include scaling (e.g., multiplying) the AV ratio with a number (e.g., 10) such that the AV ratio has an integer value. For example, an AV ratio having a value of 1.2 may be normalized to provide an AV ratio having a value of 12. In other examples, normalizing the AV ratio may include rounding the AV ratio to a particular digit resolution, adjusting the AV ratio to a particular scale, and/or adjusting the AV ratio based on one or more probabilities.

In some cases, the AV ratio may be known to fall within a particular range, and accordingly may be used to classify the content of a macroblock. A relatively low AV ratio may indicate a macroblock defines an edge, a relatively high AV ratio may indicate a macroblock defines noise, and an intermediate AV ratio may indicate a macroblock defines a texture. In some examples, ranges and/or AV ratios may be stored in a mode decision block, such as the mode decision block 230 of FIG. 2. Ranges may be specified by a user and/or may be determined based, at least in part, on a video signal. By way of example, an AV ratio may fall within a range having a minimum value of 0 and a maximum value of 26. If the AV ratio has a value less than or equal to 10, the content of the macroblock may be classified as having an edge. If the AV ratio has a value greater than or equal to 20, the content of the macroblock may be classified as having noise. If the AV ratio has a value between 10 and 20, the content of the macroblock may be classified as having a texture. Accordingly, multiple ranges of AV ratios may be defined, each corresponding to a different type of macroblock for which a different QP adjustment may take place.

In this manner, a metric (e.g. an AV ratio) for each or selected macroblocks of a video signal may be calculated that may represent a ratio between activity and variance of the macroblock. The metric may be used to calculate (e.g. adjust) the quantization parameter for the macroblock.

It will be appreciated that while the formulas described herein are directed to a 16×16 pixel macroblock, each formula may be applied to other sized coding units as well, for instance, by adjusting the respective upper bounds of summation for each summation notation accordingly.

In some examples, AV ratios of macroblocks having relatively low activity may not be reliable. For example, the probability of misclassifying content of a macroblock may increase as the activity of the macroblock decreases, and as a result AV ratios may need to be corrected for these respective macroblocks. FIG. 4 is a flowchart of a method 400 for correcting an activity-variance ratio of a macroblock having relatively low activity according to an embodiment of the present invention. The method 400 may be implemented using the mode decision block 230 of FIG. 2. At step 405, the mode decision block 230 may be determine whether the level of activity (e.g., the level of activity used to determine an AV ratio) of a macroblock is below a particular threshold. If the level of activity is not below the threshold, the method 400 ends. If the level of activity is below the threshold, at step 410, the mode decision block 230 may adjust the AV ratio to provide a new AV ratio. For example, in one embodiment, the AV ratio may be scaled toward a median value of the AV ratio. In other embodiments, the AV ratio may be scaled toward a low end of a range or a high end of a range.

In some instances, the method 400 may be expressed, at least in part, using pseudo code. For example, the method 400 may be expressed as the following:

if (ACT<512) {ACTVAR=(13*(512−ACT)+ACT*ACTVAR+256)/512}

where ACT represents the level of activity and ACTVAR represents the AV ratio of a macroblock, respectively. Briefly, if activity is relatively low (e.g., below 512), the AV ratio (e.g., ACTVAR) of a macroblock may be scaled toward a median AV ratio value (e.g., 13). The degree to which the AV ratio (e.g., ACTVAR) is scaled may include weighting the median AV ratio value (e.g., 13) based on the “flatness” of the content of the macroblock (e.g., activity level). In some examples, the lower the activity, the more an AV ratio may be weighted toward a median AV ratio value. For example, an AV ratio may be determined by (1) subtracting a level of activity from a value 512 and multiplying the result by 13 and (2) multiplying the level of activity by the AV ratio. The two results may be added, increased by 256 to round the result, and the total result may be divided by 512 to provide a new AV ratio.

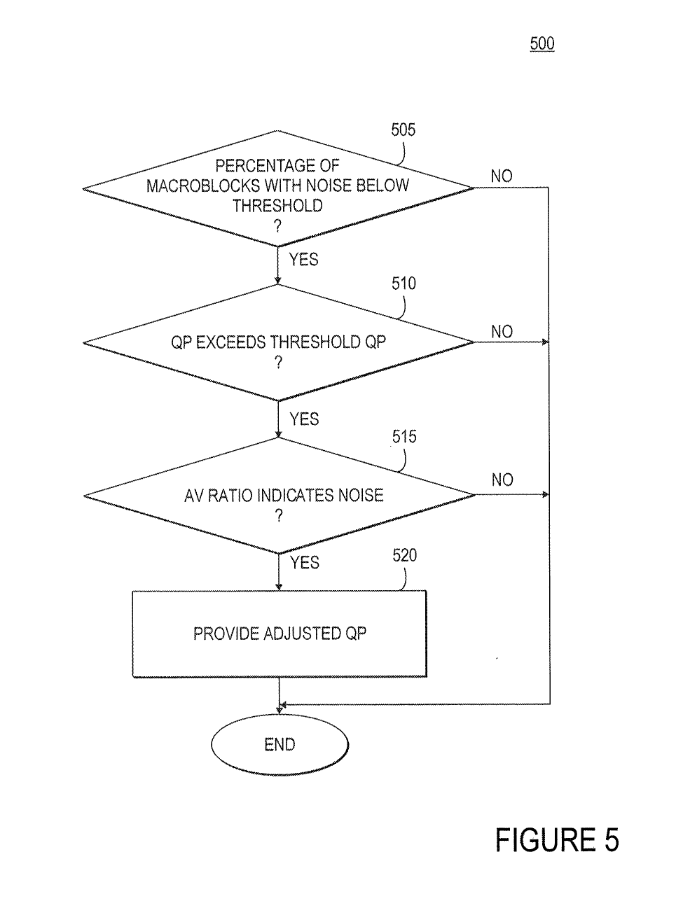

FIG. 5 is a flowchart of a method 500 for selectively adjusting a quantization parameter using an activity-variance ratio according to an embodiment of the present invention. The method 500 may be implemented using the mode decision block 230 of FIG. 2 and may be performed at a macroblock level. At step 505, for a first macroblock of a frame, the mode decision block 230 may determine a percentage of macroblocks of the frame having an AV ratio within a particular range (e.g. within the range indicative of the macroblock including noise). The mode decision block 230 may then determine whether the percentage of macroblocks of the frame in the range (e.g. with noise) is below a threshold percentage (e.g., 80%). If the percentage of macroblocks is not below the threshold percentage, the method 500 may end.

If the percentage of macroblocks is below the threshold percentage, at step 510, the mode decision block 230 may determine whether a quantization parameter of the first macroblock exceeds a threshold quantization parameter. In some examples, the threshold quantization parameter may represent an average quantization parameter of the frame in which the macroblock is included and/or may represent a target quantization parameter. A target quantization parameter may be provided by a user and/or may be based, at least in part, on one or more metrics of a video signal (e.g., rate, distortion). If the quantization parameter does not exceed the threshold quantization parameter, the method 500 may end. If the method 500 ends, no adjustment to a quantization parameter calculated in a standard manner may be made. Ending of the method 500 may indicate that no quantization parameter adjustment is needed, or that the quantization parameter should be calculated in a manner which is not affected by the particular AV ratio.

If the quantization parameter exceeds the threshold quantization parameter, at step 515, the mode decision block 230 may determine whether the macroblock has an AV ratio in a particular range (e.g. has been classified as including noise). For example, the mode decision block 230 may determine whether the AV ratio of the macroblock indicates the content of the macroblock includes noise. If the AV ratio does not indicate that the content of the macroblock includes noise, the method 500 may end.

If the AV ratio indicates that the macroblock includes noise, at step 520, the mode decision block 230 may adjust the quantization parameter of the macroblock to provide an adjusted quantization parameter, as described above. By way of example, the mode decision block 230 may adjust the quantization parameter of the macroblock by interpolating (e.g., averaging) the quantization parameter of the macroblock and the average quantization parameter of the frame of which the macroblock is a part. The interpolation may be weighted based, at least in part, on the magnitude of the AV ratio and/or may be calculated using bilinear interpolation.

In this manner, the method 500 may be implemented for the remaining macroblocks of the frame. In some embodiments, for the remaining macroblocks of the frame, the step 505 may be omitted such that the same determination made at step 505 for a first macroblock of a frame is used for all other macroblocks of the frame. In other embodiments, the step 505 may be performed for some or all remaining macroblocks of a frame.

In some instances, the method 500 may be expressed, at least in part, using pseudo code. For example, the method 500 may be expressed as the following:

if (frame_macroblocks_noise<80 && ACTVAR>20 && mp_{—}qp>frame_{—}qp{gain=max(11, 20−ACTVAR+16); mp_{—}qp=(mp_{—}qp*gain+(16−gain)*frame_{—}qp+8)/16; }

where frame_macroblocks_noise represents a percentage of macroblocks of a frame having noise, mp_qp represents a quantization parameter for a respective macroblock, frame_qp represents the average quantization parameter of a frame including the macroblock, and gain represents an interpolation variable used in determining an adjusted quantization parameter. Generally, for each macroblock of a frame having 80% or more macroblocks including noise, if a macroblock has an AV ratio indicating noise and a quantization parameter exceeding a threshold quantization parameter, the quantization parameter of the macroblock may be adjusted. Adjusting the quantization parameter may include interpolating the average quantization parameter of the frame and the quantization parameter of the macroblock to provide a new quantization parameter for the macroblock. For example, the AV ratio (e.g., ACTVAR) of the macroblock may be used to determine an interpolation variable (e.g., gain) that may be used to weight interpolation of the quantization parameter. For instance, the interpolation variable may (1) be multiplied by the quantization parameter of the macroblock and (2) subtracted from a value of 16, with the result multiplied by the average frame quantization parameter. The resulting two values may be added, increased by 8 and the total divided by 16 to provide an adjusted quantization parameter.

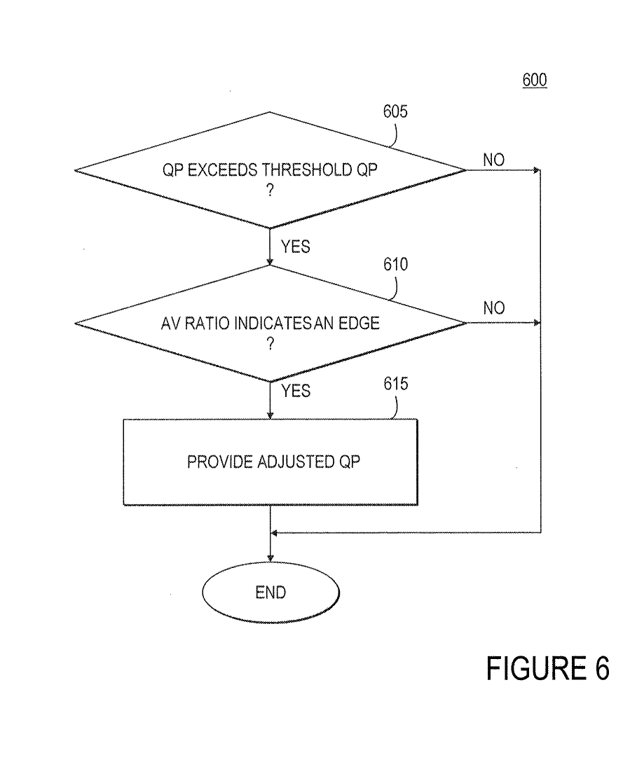

FIG. 6 is a flowchart of a method 600 for selectively adjusting a quantization parameter using an activity-variance ratio according to an embodiment of the present invention. The method 600 may be implemented by the mode decision block 230 of FIG. 2 and may be implemented at a macroblock level. At step 605, the mode decision block 230 may determine whether a quantization parameter of a macroblock exceeds a threshold quantization parameter. As described, the threshold quantization parameter may be an average quantization parameter of a frame of which the macroblock is a part and/or may be a target quantization parameter. If the quantization parameter does not exceed the threshold quantization parameter, the method 600 may end.

If the quantization parameter exceeds the threshold quantization parameter, at step 610, the mode decision block 230 may determine whether the macroblock's AV ratio falls within a particular range (e.g. has been classified as including an edge). For example, the mode decision block 230 may determine whether the AV ratio of the macroblock indicates that the content of the macroblock includes an edge. If the AV ratio does not indicate that the content of the macroblock includes an edge, the method 600 may end.

If the AV ratio indicates that the macroblock includes an edge, at step 615, the mode decision block 230 may adjust the quantization parameter of the macroblock to provide an adjusted quantization parameter. By way of example, the mode decision block 230 may adjust the quantization parameter of the macroblock by interpolating (e.g., averaging) the quantization parameter of the macroblock and the average quantization parameter of the frame of the macroblock. The interpolation may be weighted based, at least in part, on the magnitude of the AV ratio and/or may include bilinear interpolation.

In some instances, the method 600 may be expressed, at least in part, using pseudo code. For example, the method 600 may be expressed as the following:

if (mp_{—}qp>frame_{—}qp && ACTVAR<10) {av=max(2,ACTVAR);

mp_{—}qp=(mp_{—}qp*(av−2)+(10−av)*frame_{—}qp+4)/8; }

where mp_qp represents a quantization parameter for a respective macroblock, frame_qp represents the average quantization parameter of a frame, and av represents an interpolation variable used in determining an adjusted quantization parameter. Generally, then, for each macroblock of a frame, if a macroblock has an AV ratio indicating an edge and a quantization parameter exceeding a threshold quantization parameter, the quantization parameter of the macroblock may be adjusted. Adjusting the quantization parameter may include interpolating the average quantization parameter of the frame and the quantization parameter of the macroblock to provide a new quantization parameter for the macroblock. For example, the AV ratio (e.g., ACTVAR) of the macroblock may be used to determine an interpolation variable (e.g., av) that may be used to weight interpolation of the quantization parameter. For instance, the interpolation variable may be (1) decreased by 2 and multiplied by the quantization parameter of the macroblock and may also be (2) subtracted from a value of 10, with the result multiplied by the average frame quantization parameter. The resulting two values may be added, increased by 4 and the total divided by 8 to provide an adjusted quantization parameter.

While the methods 500 and 600 are described herein as being applied macroblock level, in some embodiments, the methods 500 and 600 may be applied at other coding unit levels as well, such as at a frame level. For example, the methods 500 and 600 may be employed to adjust an average quantization parameter for one or more frames of a video signal.

One or more steps of the methods 500 and 600 may be omitted in some examples. For example, the method 500 may be performed without performing the step 505 such that the percentage of macroblocks of a frame having noise need not be considered. Moreover, the methods 500 and 600 may be performed separately, sequentially, and/or concurrently, and may be performed by the mode decision block 230, as described, or may partially or fully be performed by one or more other components of an encoder. By way of example, in one embodiment, the mode decision block 230 may classify content of a macroblock and the quantization block 222 may adjust quantization parameters.

Encoders described herein may operate in accordance with one or more coding methodologies, and during operation, quantization parameters may be adjusted in accordance with the coding methodologies. However, random noise, edges, and/or other characteristics of a video signal may cause particular encoding methodologies to adjust quantization parameters in undesirable manners. For example, encoders employing adaptive quantization may overly adjust quantization parameters to compensate for noise. Accordingly, as described at steps 520 and 615, quantization parameters may be adjusted, and specifically may be interpolated with frame average quantization parameters. In this manner, quantization parameters deviating too far as a result of a particular encoding methodology may be adjusted.

One or more of the methods described herein and/or any pseudocode described herein, may be implemented as computer executable instructions stored on computer readable media and/or executed on one or more processors or processor cores. Computer readable media may include any form of computer readable storage or computer readable memory, transitory or non-transitory, including but not limited to externally or internally attached hard disk drives, solid-state storage (such as NAND flash or NOR flash media), tiered storage solutions, storage area networks, network attached storage, and/or optical storage.

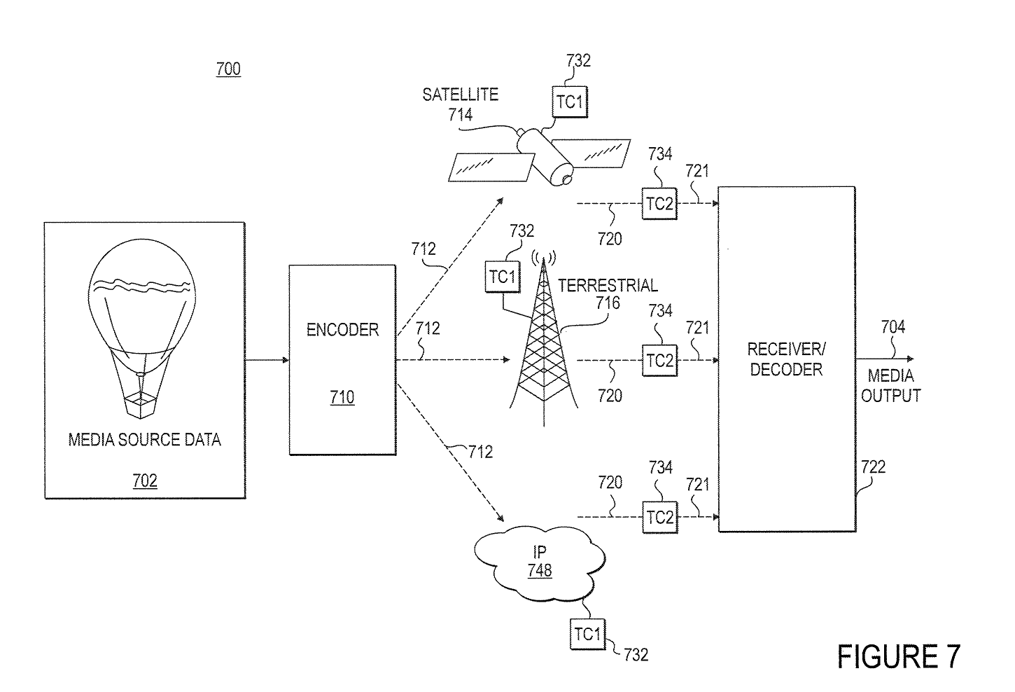

FIG. 7 is a schematic illustration of a media delivery system 700 in accordance with embodiments of the present invention. The media delivery system 700 may provide a mechanism for delivering a media source 702 to one or more of a variety of media output(s) 704. Although only one media source 702 and media output 704 are illustrated in FIG. 7, it is to be understood that any number may be used, and examples of the present invention may be used to broadcast and/or otherwise deliver media content to any number of media outputs.

The media source data 702 may be any source of media content, including but not limited to, video, audio, data, or combinations thereof. The media source data 702 may be, for example, audio and/or video data that may be captured using a camera, microphone, and/or other capturing devices, or may be generated or provided by a processing device. Media source data 702 may be analog or digital. When the media source data 702 is analog data, the media source data 702 may be converted to digital data using, for example, an analog-to-digital converter (ADC). Typically, to transmit the media source data 702, some type of compression and/or encryption may be desirable. Accordingly, an encoder 710 may be provided that may encode the media source data 702 using any encoding method in the art, known now or in the future, including encoding methods in accordance with video standards such as, but not limited to, MPEG-2, MPEG-4, H.264, H.HEVC, or combinations of these or other encoding standards. The encoder 710 may be implemented using any encoder described herein, including the encoder 100 of FIG. 1 and the encoder 200 of FIG. 2.

The encoded data 712 may be provided to a communications link, such as a satellite 714, an antenna 716, and/or a network 748. The network 748 may be wired or wireless, and further may communicate using electrical and/or optical transmission. The antenna 716 may be a terrestrial antenna, and may, for example, receive and transmit conventional AM and FM signals, satellite signals, or other signals known in the art. The communications link may broadcast the encoded data 712, and in some examples may alter the encoded data 712 and broadcast the altered encoded data 712 (e.g. by re-encoding, adding to, or subtracting from the encoded data 712). The encoded data 720 provided from the communications link may be received by a receiver 722 that may include or be coupled to a decoder. The decoder may decode the encoded data 720 to provide one or more media outputs, with the media output 704 shown in FIG. 7.

The receiver 722 may be included in or in communication with any number of devices, including but not limited to a modem, router, server, set-top box, laptop, desktop, computer, tablet, mobile phone, etc.

The media delivery system 700 of FIG. 7 and/or the encoder 710 may be utilized in a variety of segments of a content distribution industry.

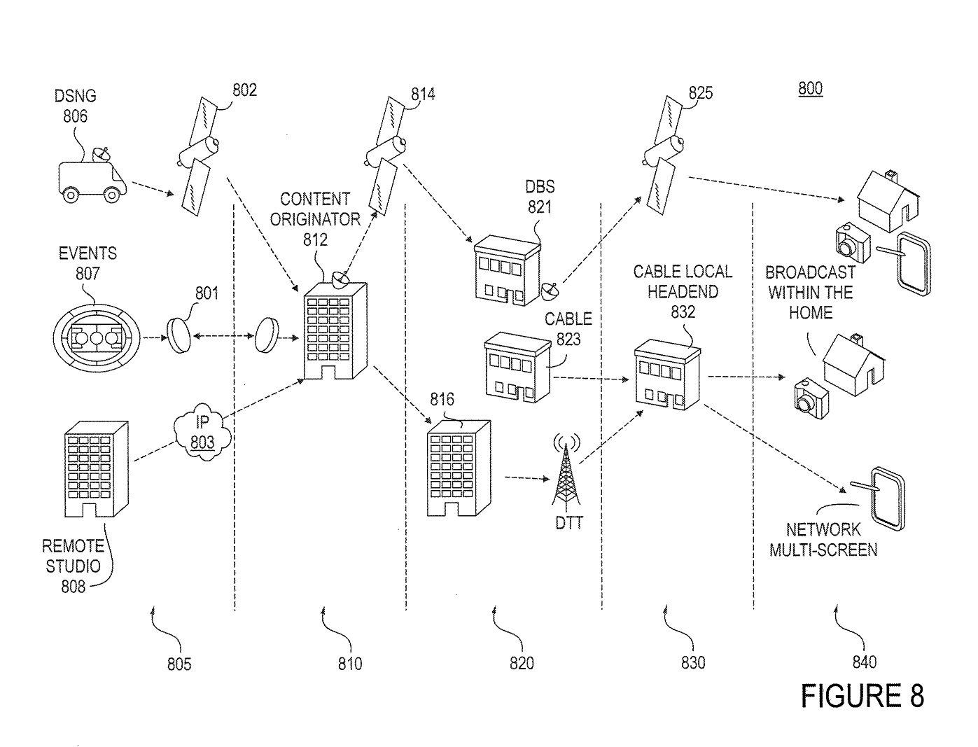

FIG. 8 is a schematic illustration of a video distribution system that 800 may make use of encoders described herein. The video distribution system 800 includes video contributors 805. The video contributors 805 may include, but are not limited to, digital satellite news gathering systems 806, event broadcasts 807, and remote studios 808. Each or any of these video contributors 805 may utilize an encoder described herein, such as the encoder 710 of FIG. 7, to encode media source data and provide encoded data to a communications link. The digital satellite news gathering system 806 may provide encoded data to a satellite 802. The event broadcast 807 may provide encoded data to an antenna 801. The remote studio 808 may provide encoded data over a network 803.

A production segment 810 may include a content originator 812. The content originator 812 may receive encoded data from any or combinations of the video contributors 805. The content originator 812 may make the received content available, and may edit, combine, and/or manipulate any of the received content to make the content available. The content originator 812 may utilize encoders described herein, such as the encoder 710 of FIG. 7, to provide encoded data to the satellite 814 (or another communications link). The content originator 812 may provide encoded data to a digital terrestrial television system 816 over a network or other communication link. In some examples, the content originator 812 may utilize a decoder to decode the content received from the contributor(s) 805. The content originator 812 may then re-encode data and provide the encoded data to the satellite 814. In other examples, the content originator 812 may not decode the received data, and may utilize a transcoder to change an encoding format of the received data.

A primary distribution segment 820 may include a digital broadcast system 821, the digital terrestrial television system 816, and/or a cable system 823. The digital broadcasting system 821 may include a receiver, such as the receiver 722 described with reference to FIG. 7, to receive encoded data from the satellite 814. The digital terrestrial television system 816 may include a receiver, such as the receiver 722 described with reference to FIG. 7, to receive encoded data from the content originator 812. The cable system 823 may host its own content which may or may not have been received from the production segment 810 and/or the contributor segment 805. For example, the cable system 823 may provide its own media source data 702 as that which was described with reference to FIG. 7.

The digital broadcast system 821 may include an encoder, such as the encoder 710 of FIG. 7, to provide encoded data to the satellite 825. The cable system 823 may include an encoder, such as the encoder 710 of FIG. 7, to provide encoded data over a network or other communications link to a cable local headend 832. A secondary distribution segment 830 may include, for example, the satellite 825 and/or the cable local headend 832.

The cable local headend 832 may include an encoder, such as the encoder 710 of

FIG. 7, to provide encoded data to clients in a client segment 740 over a network or other communications link. The satellite 825 may broadcast signals to clients in the client segment 840. The client segment 840 may include any number of devices that may include receivers, such as the receiver 722 and associated decoder described with reference to FIG. 7, for decoding content, and ultimately, making content available to users. The client segment 840 may include devices such as set-top boxes, tablets, computers, servers, laptops, desktops, cell phones, etc.

Accordingly, encoding, transcoding, and/or decoding may be utilized at any of a number of points in a video distribution system. Embodiments of the present invention may find use within any, or in some examples all, of these segments.

From the foregoing it will be appreciated that, although specific embodiments of the invention have been described herein for purposes of illustration, various modifications may be made without deviating from the spirit and scope of the invention. Accordingly, the invention is not limited except as by the appended claims.

What is claimed is:

1. An apparatus, comprising:
an encoder configured to receive a macroblock and calculate a ratio between an activity of the macroblock and a variance of the macroblock, the encoder further configured to selectively adjust a quantization parameter associated with the macroblock based, at least in part, on the activity-variance ratio.

2. The apparatus of claim 1, wherein the activity of the macroblock is based, at least in part, on an absolute difference between intensity of first and second adjacent pixels of the macroblock.

3. The apparatus of claim 1, wherein the variance of the macroblock corresponds with an absolute difference between the intensity of the pixels of the macroblock and an average intensity of the macroblock.

4. The apparatus of claim 2, wherein the encoder is further configured to correct the ratio responsive, at least in part, to the activity being below a threshold.

5. The apparatus of claim 1, wherein the encoder is further configured to selectively adjust the quantization parameter based, at least in part, on a target quantization parameter.

6. The apparatus of claim 5, wherein the macroblock is included in a frame, and wherein the target quantization parameter comprises an average quantization parameter associated with the frame.

7. The apparatus of claim 1, wherein the encoder is further configured to normalize the ratio.

8. The apparatus of claim 1, wherein the encoder is configured to selectively adjust the quantization parameter responsive, at least in part, to determining that content of the macroblock includes at least one of an edge or noise.

9. An encoder, comprising:
a mode decision block configured to receive a macroblock and a quantization parameter, the mode decision block further configured to determine a level of activity and a level of variance for the macroblock and to calculate a ratio between the level of activity and level of variance, the mode decision block further configured to adjust the quantization parameter using the ratio to provide an adjusted quantization parameter; and
a quantization block coupled to the mode decision block and configured to receive a plurality of coefficients associated with the macroblock and the adjusted quantization parameter, the quantization block further configured to quantize the plurality of coefficients in accordance with the adjusted quantization parameter.

10. The encoder of claim 9, wherein the encoder is further configured to operate in accordance with adaptive quantization.

11. The encoder of claim 9, wherein the mode decision block is further configured to interpolate the quantization parameter and an average quantization parameter of a frame.

12. The encoder of claim 11, wherein the mode decision block is configured to interpolate the quantization parameter and the average quantization parameter of the frame using bilinear interpolation.

13. The encoder of claim 9, wherein the level of variance is based, at least in part, on a DC coefficient associated with the macroblock

14. The encoder of claim 9, wherein the encoder is further configured to correct the ratio responsive, at least in part, to the level of activity being below a threshold.

15. A method, comprising:
receiving, with a mode decision block, a macroblock associated with a quantization parameter;
determining a level of activity of the macroblock;
determining a level of variance of the macroblock;
calculating a ratio of the level of activity and the level of variance;
adjusting the quantization parameter based, at least in part, on the ratio; and
quantizing coefficients associated with the macroblock in accordance with the adjusted quantization parameter.

16. The method of claim 15, wherein said determining a level of activity of the macroblock comprises:
determining a first pixel value difference in a vertical direction; and
determining a second pixel value difference in a horizontal direction.

17. The method of claim 15, wherein said adjusting the quantization parameter based, at least in part, on the ratio comprises:
determining whether a percentage of macroblocks of a frame associated with the macroblock including noise is below a percentage threshold;
if the percentage of macroblocks is below the percentage threshold, determining whether the quantization parameter exceeds a target quantization parameter;
if the quantization parameter exceeds the target quantization parameter, determining whether the ratio indicates the macroblock includes noise; and
if the activity-variance ratio indicates the macroblock includes noise, interpolating the quantization parameter with an average quantization parameter of the frame.

18. The method of claim 15, wherein said adjusting the quantization parameter based, at least in part, on the ratio comprises:
determining whether the quantization parameter exceeds a target quantization parameter;
if the quantization parameter exceeds the target quantization parameter, determining whether the ratio indicates the macroblock includes an edge; and
if the ratio indicates the macroblock includes an edge, interpolating the quantization parameter with an average quantization parameter of the frame.

19. The method of claim 15, further comprising:
correcting the ratio responsive, at least in part, to determining that the level of activity is below a threshold.

20. The method of claim 15, wherein said determining a level of variance of the macroblock comprises:
determining an absolute difference between a pixel value and a DC coefficient of the macroblock.
